(19) United States
(12) Patent Application Publication
(10) Pub. No.: US 2025/0389543 A1
(43) Pub. Date: Dec. 25, 2025

(54) SYSTEMS AND METHODS FOR NAVIGATING BASED ON CRIME AVOIDANCE

(71) Applicants: Naphtali D. Rishe, Miami, FL (US); Malek Adjouadi, Miami, FL (US)

(72) Inventors: Naphtali D. Rishe, Miami, FL (US); Malek Adjouadi, Miami, FL (US)

(21) Appl. No.: 18/752,152

(22) Filed: Jun. 24, 2024

(51) Int. Cl. G01C 21/34; G01C 21/36

(52) U.S. Cl. CPC G01C 21/3461; G01C 21/3676

(57) ABSTRACT

Systems and methods are provided for generating routes taking into consideration user preferences for crime avoidance, in addition to or alternatively to time, distance, and/or cost. User preferences for crime avoidance during a trip from one location to another can be quantified and used to augment standard routing methods by giving weight to crime avoidance. For example, a weighting triangle can be used, where a user chooses a balanced weighting of three factors, including crime avoidance, before a route from the starting location to the destination is generated. The crime rates considered can be limited to those of potentially significant impact on the user, considering the user's modality, demographics, and preferences. The relevant sub-types of crimes can be further assigned sub-weights reflecting the gravity of their potential impact on the user.

### GOVERNMENT SUPPORT

This invention was made with government support under CNS2018611 and CNS1920182 awarded by the National Science Foundation. The government has certain rights in the invention.

### BACKGROUND

Many methods exist for the optimization of routing from one location to another based on the criteria of travel time, distance, and/or cost of travel. Such routing can be in various modalities, such as by car, on foot, by bicycle, via public transit, or by boat. A typical method of routing involves building a graph comprising street segments, assigning a normalized weighted value to each segment, and then applying the weighted-shortest path algorithm to the graph in order to find the best route.

### BRIEF SUMMARY

Embodiments of the subject invention provide novel and advantageous systems and methods for generating routes (i.e., navigating) taking into consideration user preferences for crime avoidance (e.g., types of crime relevant to the particular user), in addition to or alternatively to time, distance, and/or cost. User preferences for crime avoidance during a trip from one location to another can be quantified and used to augment standard routing methods by giving weight to crime avoidance. For example, a weighting triangle can be used, where a user chooses a balanced weighting of three factors, including crime avoidance, before the system or method calculates the route from the starting location to the destination. The crime rates considered can be limited to those of potentially significant impact on the user, considering the user's modality, demographics, and/or preferences. The relevant sub-types of crimes can be further assigned sub-weights reflecting the gravity of their potential impact on the user.

In an embodiment, a system for generating a route from a starting location to a destination can comprise: a processor; a display in operable communication with the processor; and a machine-readable medium in operable communication with the processor and having instructions stored thereon that, when executed by the processor, perform the following steps: receiving first data comprising the starting location, the destination, and a relative preference of a user of the system for crime avoidance compared to at least one other objective, the at least one other objective comprising time of the route, cost of the route, and distance of the route; utilizing map data to generate segments of potential paths between the starting location and the destination; running an algorithm (e.g., a weighted-shortest path algorithm) on the segments of potential paths, using the relative preference, to generate the route from the starting location to the destination; and displaying, on the display, the route to the user of the system. The relative preference can be set by the user using a weighted selection triangle; for example, the relative preference can comprise a weighted selection triangle of the importance of crime avoidance (i.e., how much the user values avoiding crime along the route) and two other objectives, the two other objectives comprising two of the time of the route, the cost of the route, and the distance of the route. Within the weighting, specific sub-types of crimes (e.g., homicide, robbery, battery) can be further assigned sub-weights reflecting the gravity of their potential impact on the user (e.g., homicide can be assigned a higher sub-weight than robbery). Sub-types of crimes with a higher sub-weight can have a greater influence on weighted selection triangle. The instructions when executed can further perform the following step: performing a query on a crime database to determine crime rates along the segments of potential paths. The algorithm can use the crime rates along the segments of potential paths while generating the route from the starting location to the destination. The crime rates can be limited to rates for crimes relevant to the user of the system. For example, the crimes relevant to the user of the system can include violent outdoor crimes (e.g., homicides) and/or exclude any or all of domestic violence, insider trading, code violations, and statutory rape. The instructions when executed can further perform the following steps: receiving second data from the user of the system comprising whether the displayed route is acceptable; and if the second data indicates the displayed route is unacceptable, allowing the user of the system to update the relative preference, running the algorithm again using the updated relative preference to generate an updated route, and displaying the updated route to the user of the system. The first data can further comprise at least one choice of the user of the system for types of crimes to exclude from or include in an evaluation of the crime avoidance, and the running of the algorithm to generate the route can further comprise using the at least one choice. The system can comprise a smart device (e.g., a smartphone or smart table), and the smart device can comprise the display, the processor, and/or the machine-readable medium.

In another embodiment, a method for generating a route from a starting location to a destination can comprise: receiving (e.g., by a processor) first data comprising the starting location, the destination, and a relative preference of a user of the system for crime avoidance compared to at least one other objective, the at least one other objective comprising time of the route, cost of the route, and distance of the route; utilizing (e.g., by the processor) map data to generate segments of potential paths between the starting location and the destination; running (e.g., by the processor) an algorithm (e.g., a weighted-shortest path algorithm) on the segments of potential paths, using the relative preference, to generate the route from the starting location to the destination; and displaying (e.g., by the processor) (e.g., on a display in operable communication with the processor) the route to the user. The relative preference can comprise a weighted selection triangle of the importance of crime avoidance and two other objectives, the two other objectives comprising two of the time of the route, the cost of the route, and the distance of the route. Within the weighting, specific sub-types of crimes (e.g., homicide, robbery, battery) can be further assigned sub-weights reflecting the gravity of their potential impact on the user (e.g., homicide can be assigned a higher sub-weight than robbery). Sub-types of crimes with a higher sub-weight can have a greater influence on weighted selection triangle. The method can further comprise performing (e.g., by the processor) a query on a crime database to determine crime rates along the segments of potential paths. The algorithm can use the crime rates along the segments of potential paths while generating the route from the starting location to the destination. The crime rates can be limited to rates for crimes relevant to the user of the system. For example, the crimes relevant to the user of the system can include violent outdoor crimes (e.g., homicides) and/or exclude any or all of domestic violence, insider trading, code violations, and statutory rape. The method can further comprise: receiving (e.g., by the processor) second data from the user comprising whether the displayed route is acceptable; and if the second data indicates the displayed route is unacceptable, allowing (e.g., by the processor) the user to update the relative preference, running (e.g., by the processor) the algorithm again using the updated relative preference to generate an updated route, and displaying (e.g., by the processor) (e.g., on the display) the updated route to the user. The first data can further comprise at least one choice of the user of the system for types of crimes to exclude from or include in an evaluation of the crime avoidance, and the running of the algorithm to generate the route can further comprise using the at least one choice.

### BRIEF DESCRIPTION OF DRAWINGS

FIG. 1 shows a map image of routing that optimizes time and/or distance.

FIG. 2 shows a query to a crime database.

FIG. 3 shows a map of incidents based on the query from FIG. 2.

FIG. 4 shows a tabular output of the query from FIG. 2.

FIG. 5 shows a homicide query to a crime database.

FIG. 6 shows a map of incidents based on the homicide query from FIG. 5.

FIG. 7 shows a tabular output of the homicide query from FIG. 5.

FIG. 8 shows a query to a crime database, not restricting crime types.

FIG. 9 shows a map of incidents based on the query from FIG. 8.

FIG. 10 shows a tabular output of the query from FIG. 8.

FIG. 11 shows a map image of time-optimized routing that takes into account crime, going through segments with higher crime potential.

FIG. 12 shows a map image of routing that takes into account both crime avoidance and time (i.e., co-optimizing crime avoidance and time), according to an embodiment of the subject invention.

FIG. 13 shows a map image of routing that takes into account both crime avoidance and time (i.e., co-optimizing crime avoidance and time) for various transportation modalities, according to an embodiment of the subject invention.

FIG. 14A shows a weighting triangle with values along one side.

FIG. 14B shows a weighting triangle with weighting values along all three sides.

FIG. 14C shows an image of a smart device with the weighting triangle of FIG. 14B displayed thereon, showing a user selecting different weighting points.

### DETAILED DESCRIPTION

Embodiments of the subject invention provide novel and advantageous systems and methods for generating routes (i.e., navigating) taking into consideration user preferences for crime avoidance (e.g., types of crime relevant to the particular user), in addition to or alternatively to time, distance, and/or cost. User preferences for crime avoidance during a trip from one location to another can be quantified and used to augment standard routing methods by giving weight to crime avoidance. For example, a weighting triangle can be used, where a user chooses a balanced weighting of three factors, including crime avoidance, before the system or method calculates the route from the starting location to the destination. The crime rates considered can be limited to those of potentially significant impact on the user, considering the user's modality, demographics, and/or preferences. The relevant sub-types of crimes can be further assigned sub-weights reflecting the gravity of their potential impact on the user (e.g., homicide can be assigned a higher sub-weight than robbery).

Many users of systems and methods that provide routing calculation and/or assistance desire that the routing include consideration pertaining to the reduction of risk of encountering crime (e.g., violent crime) on the path or route from the starting location to the destination. For example, a user may desire a leisure walk via a safe route from a hotel in an unknown city. Embodiments of the subject invention can quantify such user preferences and the risks of encountering crime to augment routing (e.g., standard routing methods) by giving weight to said safety considerations.

Embodiments of the subject invention provide systems and methods to co-optimize crime avoidance with other criteria when generating routes from a starting location to a destination. In comparison to related art systems and methods for route generation, the systems and methods of embodiments of the subject invention have many advantages (see also, e.g., Kanoulas et al., Finding Fastest Paths on A Road Network with Speed Patterns, In 22nd International Conference on Data Engineering (ICDE'06), 2006, pp. 10-10, doi: 10.1109/ICDE.2006.71; Joo et al., A new route guidance method considering the pedestrian level of service using a multi-criteria decision-making technique, Journal of Korea Spatial Information Society, 19, pp. 83-91, 2011; Shekelyan et al., Linear Path Skyline Computation in Bicriteria Networks, International Conference on Database Systems for Advanced Applications (DASFAA 2014), Lecture Notes in Computer Science, volume 8421, Springer, pp. 173-187, 2014; and Galbrun et al., Urban navigation beyond shortest route: The case of safe paths, Information Systems, Volume 57, pages 160-171, 2016; all four of which are hereby incorporated herein by reference in their entireties). These advantages include weighting crime types with respect to their potential detrimental value to the user, weighting crime types with temporal qualification, quantification of crime and its statistical aggregation at the geographic resolution down to a city block, and valuation of the crime detriment to the user in each segment by considering the needs, exposure, and preferences of the user rather than merely considering the general crime incidence statistics.

For example, violent crimes committed outdoors have a higher impact, with severe violence (e.g., homicide in the street) having the highest impact. Crimes without a direct unrelated victim, such as code violations or embezzlement, have no impact on travelers. Pick-pockets have an impact on travelers in walking mode but minimal impact on travelers by car. Non-statutory rape may be of high concern to a woman walking alone. For each type of traveler and travel modality, the systems and methods of embodiments of the subject invention can provide default formulas for the evaluation of crime detriment in each segment. Additionally, the user can modify the formula by assigning greater or lesser importance to various types of crimes.

In order to quantify crime risks for each street segment, police reports that occurred close to that segment during a set period of time can be counted (e.g., a particular year of reference, counting only violent and property crimes of the type that would directly affect the traveler (e.g., excluding domestic violence, insider trading, code violations, and/or statutory rape)). Weights can be assigned to various crime types based on the impact they may have on the traveler.

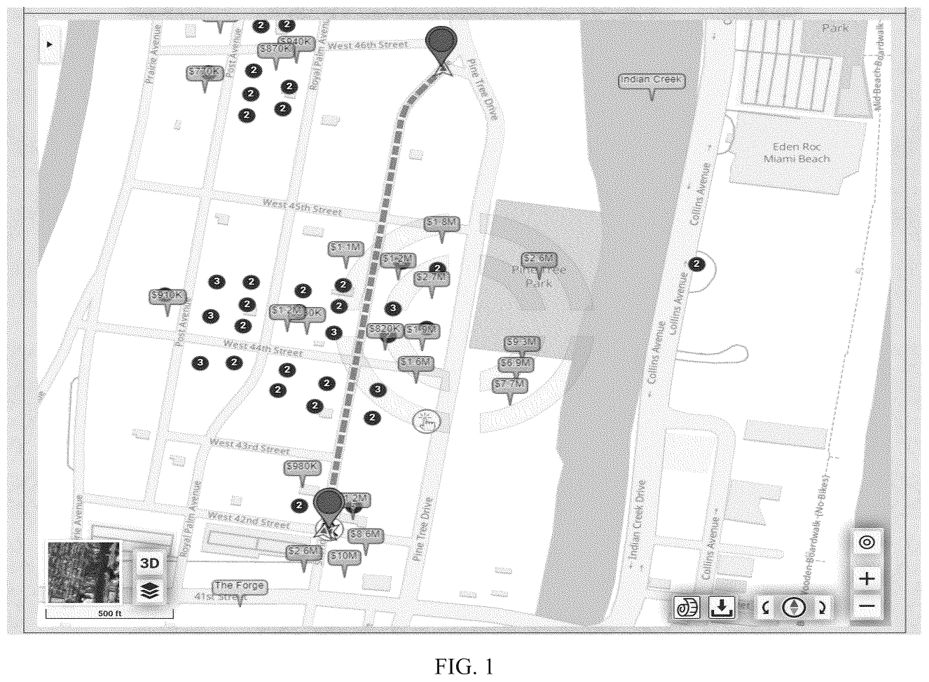

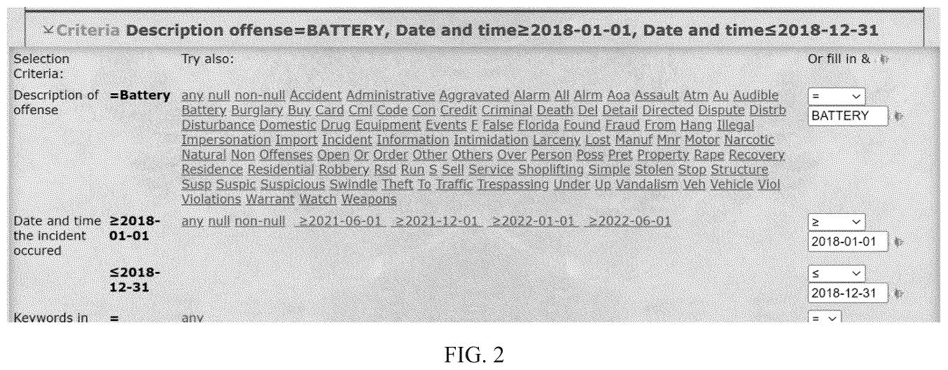

FIG. 1 shows a map image of traditional routing from a starting location to a destination, optimizing the distance and/or time (i.e., the route is the shortest distance from the starting location to the destination). FIGS. 2-13 demonstrate how systems and methods of embodiments of the subject invention can be used to generate routes (i.e., navigating) taking into consideration user preferences for crime avoidance (e.g., types of crime relevant to the particular user), in addition to or alternatively to time, distance, and/or cost.

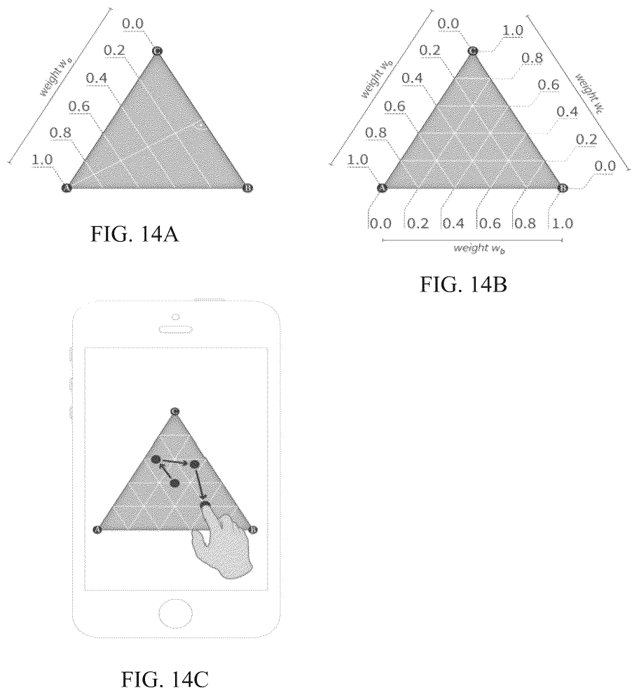

In an embodiment, the relative importance of crime avoidance, along with time, cost of travel, and/or distance, can be determined by utilizing a weight selection triangle, as seen in FIGS. 14A-14C (see also U.S. Pat. No. 10,061,501, which is hereby incorporated by reference herein in its entirety). A triangle can allow a user to assign importance weights to three decision optimization objectives. In some embodiments, the weight selection triangle can be displayed on a device (e.g., a smart device such as a smart phone; see also FIG. 14C) that allows a user to make selections of the relative importance of the objectives by touching the touchable triangle using a single gesture. Referring to FIG. 14B, a decision optimization objective a would be the only one considered if the user selected the point labeled “A” at the bottom-left of the triangle (as depicted in FIG. 14B); decision optimization objective b would be the only one considered if the user selected the point labeled “B” at the bottom-right of the triangle (as depicted in FIG. 14B); and decision optimization objective c would be the only one considered if the user selected the point labeled “C” at the top of the triangle (as depicted in FIG. 14B). Points in the body of the triangle correspond to different weights of the relative importance of the three decision optimization objectives (a, b, c), based on the relative distances from the point touched by the user within the triangle to the three corresponding vertices of the triangle. FIG. 14C shows an example where multiple weighting points are selected, which can be for different types of routing for the same starting point and destination or for different routings (i.e., different starting point and/or destination). For example, three objectives (e.g., A=time, B=cost of travel, and C=crime avoidance) can be presented in a triangular fashion on a touch screen. FIG. 14A shows the underlying principle of the establishment of a single weight (Wₐ) for Objective A; FIG. 14B combines three objectives into a single triangle, allowing for the establishment of a tri-variable weight function (Wₐ, W_{b}, and W_{c}). By applying a finger gesture, the user can move an indicator freely inside the triangle (see FIG. 14C). The position of the indicator establishes a tri-variable weight function, which in further steps, is then used as input for a co-optimization algorithm. When the user is satisfied with the established weights, the user can indicate this (e.g., by pressing a touch screen button labeled “Go”, or similar).

Embodiments of the subject invention provide a focused technical solution to the focused technical problem of how to address user preferences for navigating while taking crime avoidance into consideration. Embodiments of the subject invention optimize the convenience and utility to the user. Embodiments of the subject invention may improve the device on which the processor is located by minimizing the resources dedicated to searching (e.g., for crimes along potential paths between a starting location and a destination) and changing a calculated route in view of results of such searching. This is accomplished by providing a route generated with crime avoidance already accounted for.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e., the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

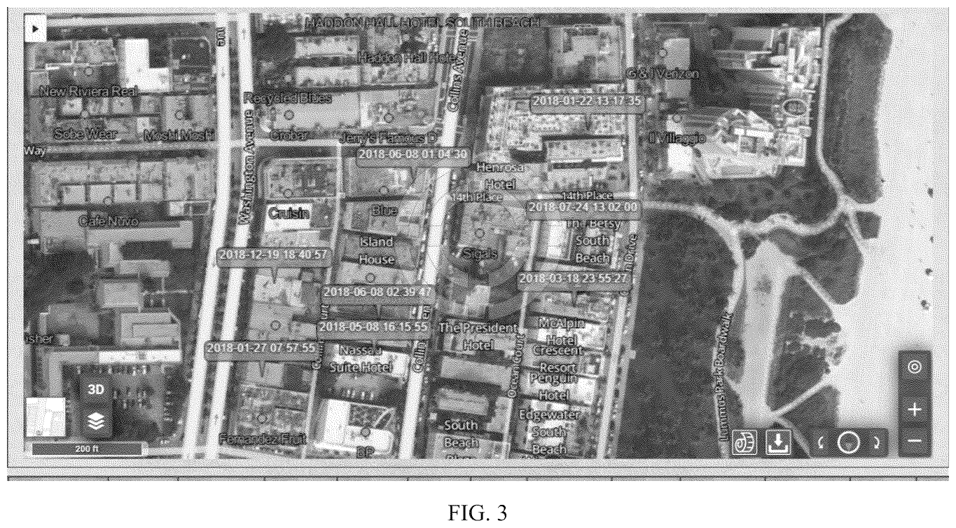

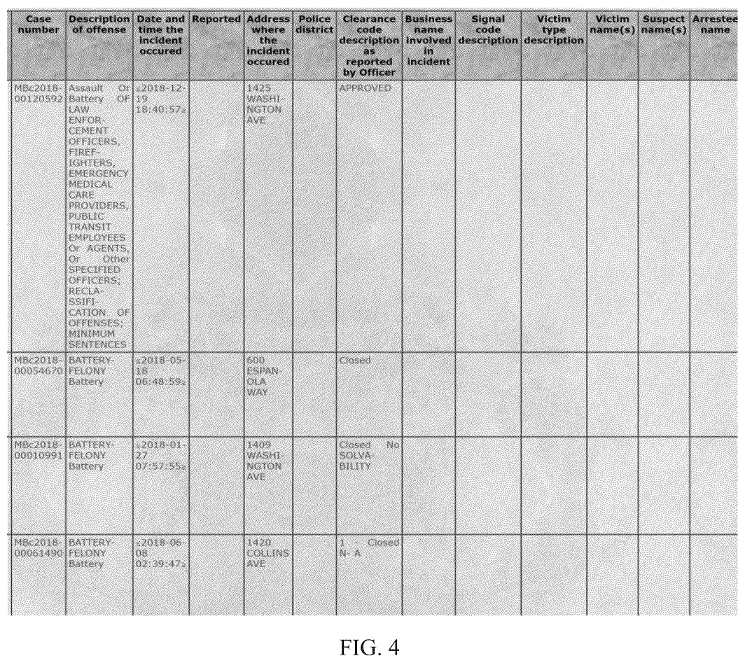

A query to a crime database for an area in mid-Miami Beach was performed. FIG. 2 shows the sample query to a crime database, which resulted in a set of incidents as shown in the map in FIG. 3 and the tabular output in FIG. 4.

### Example 2

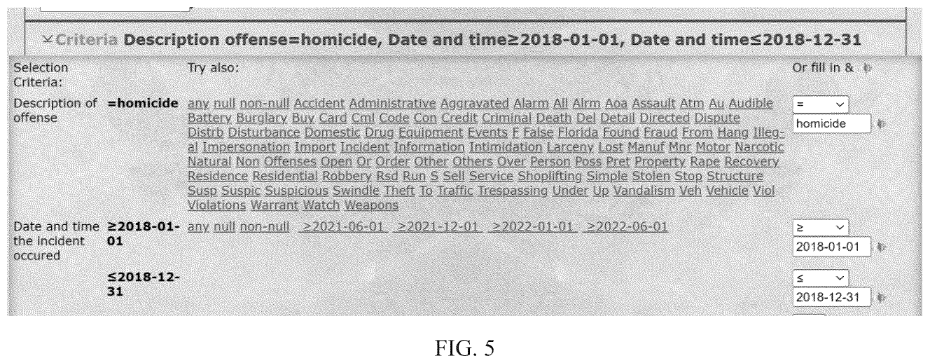

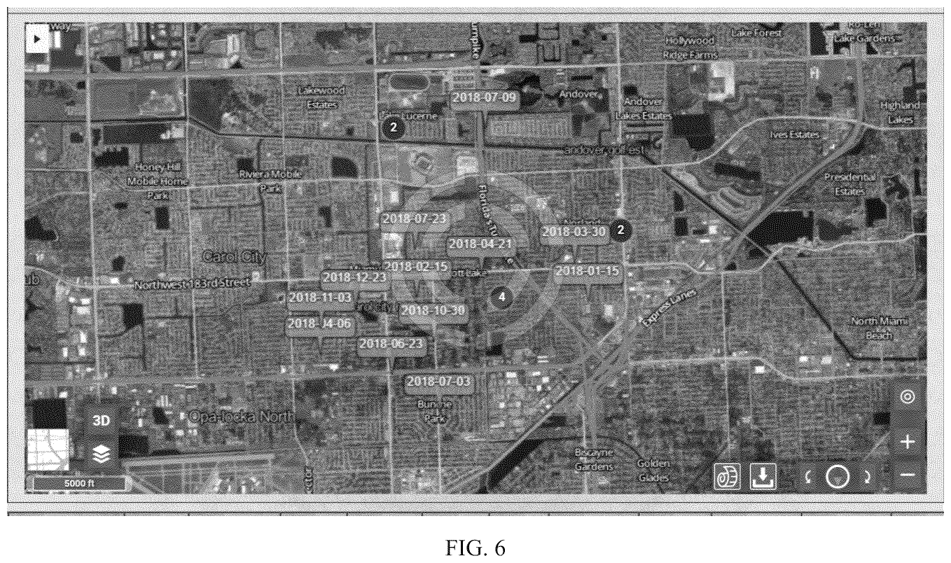

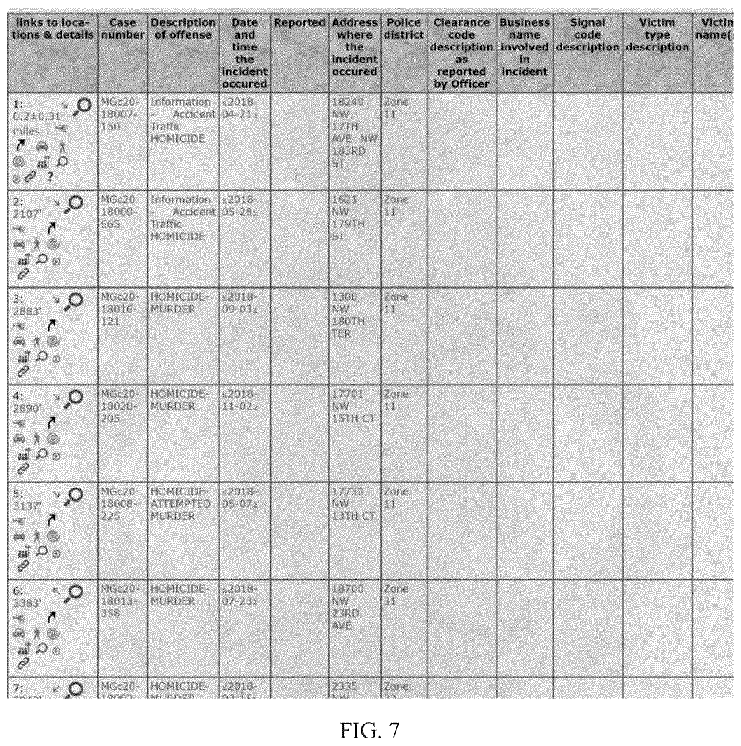

The mid-Miami Beach area of Example 1 did not have homicide reports during the sampling period. In order to see homicide reports, which can be considered with a higher weight than battery, a query was performed for an area further west. FIG. 5 shows the sample homicide query to a crime database, which resulted in a set of incidents as shown in the map in FIG. 6 and the tabular output in FIG. 7.

### Example 3

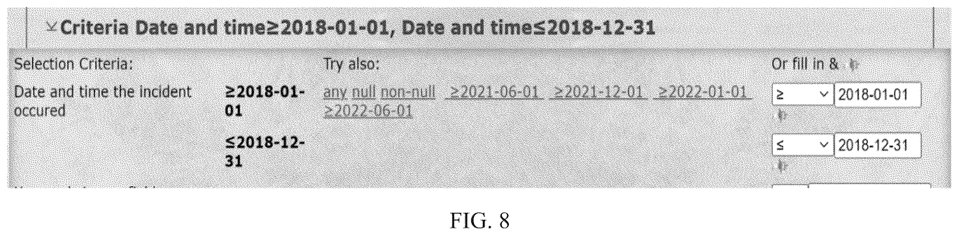

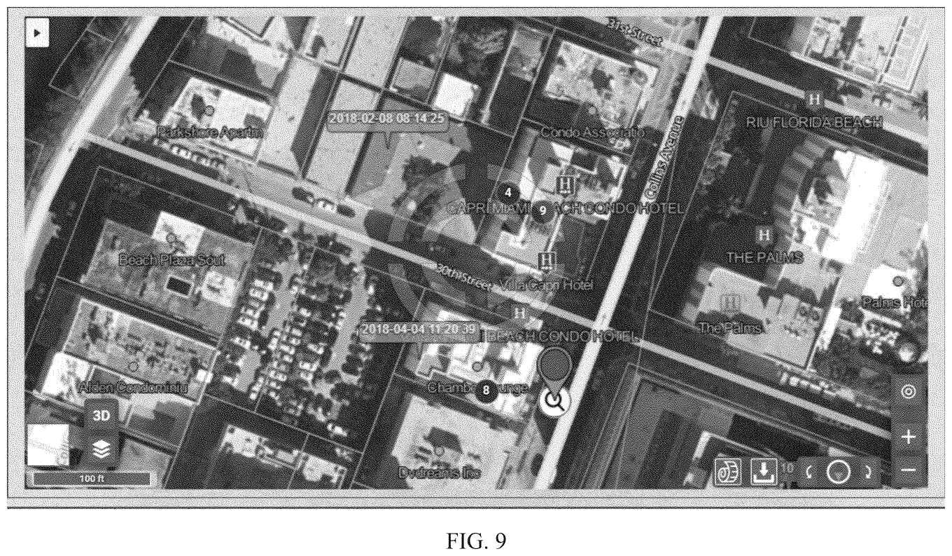

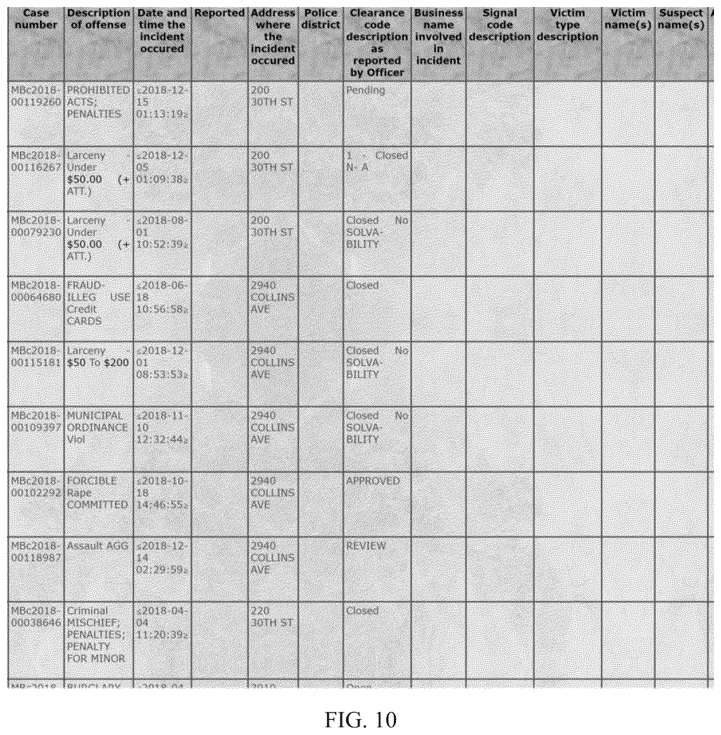

The importance of querying for only specific types of crime (and weighting them) was demonstrated by performing a query that did not restrict by crime type, which gave results that were mostly crimes that have no bearing on a prospective traveler. FIG. 8 shows an image of the sample query to a crime database (not restricting for crime type), which resulted in a set of incidents as shown in the map in FIG. 9 and the tabular output in FIG. 10.

### Example 4

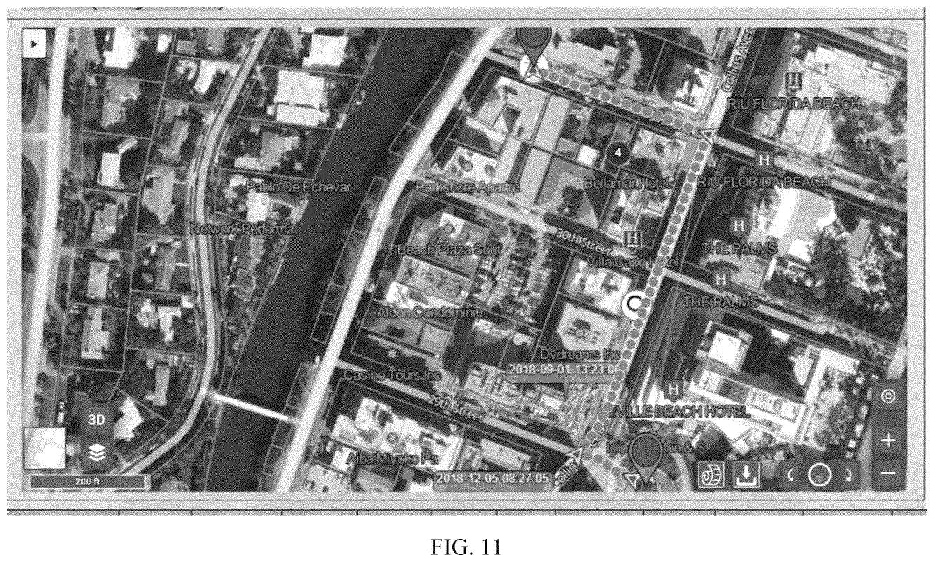

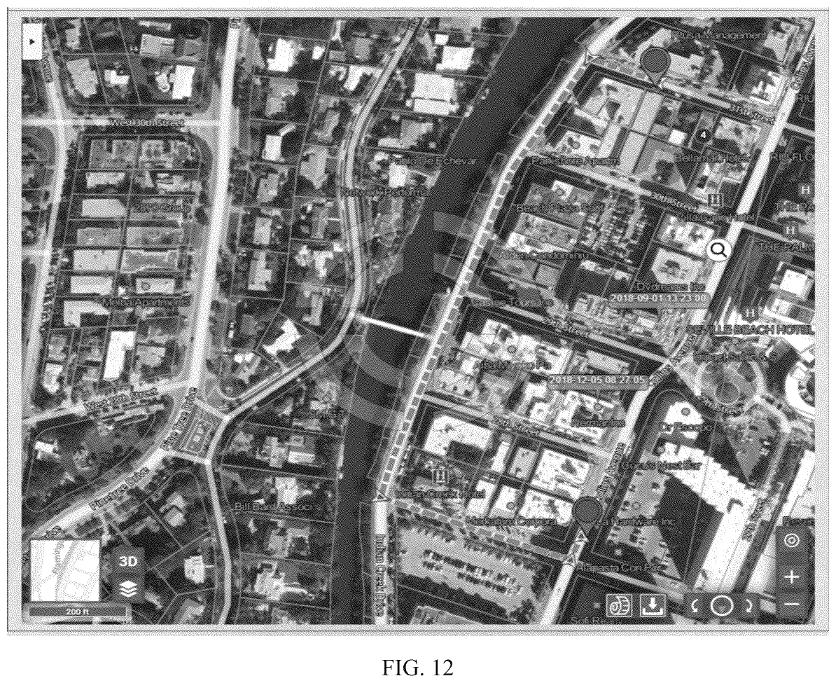

Co-optimization of time and crime avoidance was performed for routing from a starting location to a destination. FIG. 11 shows a map with a route optimizing travel time. This route traverses segments where relevant crimes have occurred during the sampling period (i.e., it does not take into account crime avoidance). FIG. 12 shows the route produced by systems and methods of the subject invention, co-optimizing time and crime avoidance; it can be seen that the route is different from that in FIG. 11, but it avoids the crimes shown with the pins along Collins Avenue (the same road as the destination marked with the flag near the bottom of the map, the crime pins being north of the destination).

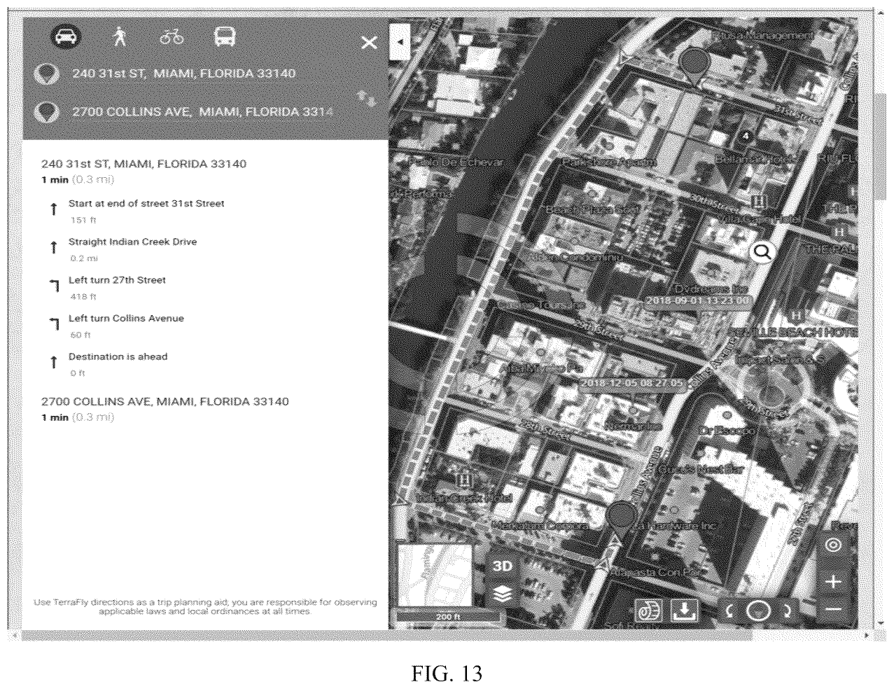

FIG. 13 shows that different transportation modalities can be selected. The route may be different depending on the transportation modality because different crime types may be weighted differently (e.g., pick-pocket crimes may be weighed less if the transportation modality is a car).

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

1. A system for generating a route from a starting location to a destination, the system comprising:
a computing device;
a processor disposed in the computing device;
a touch screen display in operable communication with the processor; and
a machine-readable medium disposed in the computing device, in operable communication with the processor, and having instructions stored thereon that, when executed by the processor, perform the following steps:
receiving first data comprising the starting location, the destination, and a relative preference of a user of the system for crime avoidance compared to at least one other objective, the at least one other objective comprising time of the route, cost of the route, and distance of the route;
utilizing map data to generate segments of potential paths between the starting location and the destination;
performing a query on a crime database to determine crime rates along the segments of potential paths;
running a weighted shortest path algorithm on the segments of potential paths, using the relative preference, to generate the route from the starting location to the destination;
displaying, on the touch screen display, the route to the user;
receiving second data via touch input from the user via the touch screen display, the second data comprising whether the displayed route is acceptable to the user;
upon the second data indicating that the displayed route is unacceptable to the user, allowing the user to update the relative preference via touch input on a weighted selection triangle from the user via the touch screen display, running the weighted shortest path algorithm again using the updated relative preference to generate an updated route, and displaying, on the touch screen display, the updated route to the user; and
providing navigation guidance to the user, via the route or the updated route, as the user travels from the starting location to the destination,
the weighted shortest path algorithm using the crime rates along the segments of potential paths while generating the route from the starting location to the destination,
the relative preference comprising the weighted selection triangle of the importance of crime avoidance and two other objectives, the two other objectives comprising two of the time of the route, the cost of the route, and the distance of the route,
the receiving of the first data comprising receiving the relative preference via touch input on the weighted selection triangle from the user via the touch screen display,
the crime rates being rates for crimes relevant to the user,
the crimes relevant to the user including outdoor homicides,
the crimes relevant to the user excluding domestic violence, insider trading, violations of city codes, and statutory rape,
the crime database having a geographic resolution down to a city block, and
the running of the weighted shortest path algorithm improving the computing device by minimizing computing resources dedicated to searching for crimes along potential paths between the starting location and the destination.

2. (canceled)

3. The system according to claim 2, the importance of crime avoidance within weighted selection triangle further comprising sub-weights assigned by the user to homicide, robbery, and battery.

4-8. (canceled)

9. The system according to claim 1, the computing device being a smart device.

10. A method for generating a route from a starting location to a destination, the method comprising:
receiving, by a processor of a computing device, first data comprising the starting location, the destination, and a relative preference of a user for crime avoidance compared to at least one other objective, the at least one other objective comprising time of the route, cost of the route, and distance of the route;
utilizing, by the processor, map data to generate segments of potential paths between the starting location and the destination;
performing a query on a crime database to determine crime rates along the segments of potential paths;
running, by the processor, a weighted shortest path algorithm on the segments of potential paths, using the relative preference, to generate the route from the starting location to the destination;
displaying, on a touch screen display in operable communication with the processor, the route to the user;
receiving second data via touch input from the user via the touch screen display, the second data comprising whether the displayed route is acceptable to the user; and
upon the second data indicating that the displayed route is unacceptable to the user, allowing the user to update the relative preference via touch input on a weighted selection triangle from the user via the touch screen display, running the weighted shortest path algorithm again using the updated relative preference to generate an updated route, and displaying, on the touch screen display, the updated route to the user; and
providing navigation guidance to the user, via the route or the updated route, as the user travels from the starting location to the destination,
the weighted shortest path algorithm using the crime rates along the segments of potential paths while generating the route from the starting location to the destination,
the relative preference comprising the weighted selection triangle of the importance of crime avoidance and two other objectives, the two other objectives comprising two of the time of the route, the cost of the route, and the distance of the route,
the receiving of the first data comprising receiving the relative preference via touch input on the weighted selection triangle from the user via the touch screen display,
the crime rates being rates for crimes relevant to the user,
the crimes relevant to the user including outdoor homicides,
the crimes relevant to the user excluding domestic violence, insider trading, violations of city codes, and statutory rape,
the crime database having a geographic resolution down to a city block, and
the running of the weighted shortest path algorithm improving the computing device by minimizing computing resources dedicated to searching for crimes along potential paths between the starting location and the destination.

11. (canceled)

12. The method according to claim 11, the importance of crime avoidance within weighted selection triangle further comprising sub-weights assigned by the user to homicide, robbery, and battery. 13-17. (Canceled)

18. A system for generating a route from a starting location to a destination, the system comprising:
a smart computing device;
a processor disposed in the smart computing device;
a touch screen display in operable communication with the processor; and
a machine-readable medium disposed in the smart computing device, in operable communication with the processor, and having instructions stored thereon that, when executed by the processor, perform the following steps:
receiving first data comprising the starting location, the destination, and a relative preference of a user of the system for crime avoidance compared to at least one other objective, the at least one other objective comprising time of the route, cost of the route, and distance of the route;
utilizing map data to generate segments of potential paths between the starting location and the destination;
performing a query on a crime database to determine crime rates along the segments of potential paths;
running a weighted shortest path algorithm on the segments of potential paths, using the relative preference, to generate the route from the starting location to the destination;
displaying, on the touch screen display, the route to the user;
receiving second data via touch input from the user via the touch screen display, the second data comprising whether the displayed route is acceptable to the user; and
upon the second data indicating that the displayed route is unacceptable to the user, allowing the user to update the relative preference via touch input on the-a weighted selection triangle from the user via the touch screen display, running the algorithm again using the updated relative preference to generate an updated route, and displaying, on the touch screen display, the updated route to the user; and
providing navigation guidance to the user, via the route or the updated route, as the user travels from the starting location to the destination,
the weighted shortest path algorithm using the crime rates along the segments of potential paths while generating the route from the starting location to the destination,
the relative preference comprising the weighted selection triangle of the importance of crime avoidance and two other objectives, the two other objectives comprising two of the time of the route, the cost of the route, and the distance of the route,
the receiving of the first data comprising receiving the relative preference via touch input on the weighted selection triangle from the user via the touch screen display,
the crime rates being rates for crimes relevant to the user,
the crimes relevant to the user including outdoor homicides,
the crimes relevant to the user excluding domestic violence, insider trading, violations of city codes, and statutory rape,
the running of the weighted shortest path algorithm improving the computing device by minimizing computing resources dedicated to searching for crimes along potential paths between the starting location and the destination,
the importance of crime avoidance within weighted selection triangle further comprising sub-weights assigned by the user to homicide, robbery, and battery, and
the crime database having a geographic resolution down to a city block.

19-20. (canceled)
